(19) United States
(12) Patent Application Publication
(10) Pub. No.: US 2006/0271660 A1
(43) Pub. Date: Nov. 30, 2006

(54) Service oriented architecture implementation planning

(75) Inventor: Mark LaJeunesse, Berlin, MA (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 11/139,424

(22) Filed: May 26, 2005

(51) Int. Cl. G06F 15/173

(52) U.S. Cl. 709/223

(57) ABSTRACT

In accordance with embodiments, there are provided mechanisms and methods for providing an implementation plan for service oriented architecture. These mechanisms and methods for providing an implementation plan make it possible for IT consultants and the like to have improved information about a customer's readiness to adopt an architecture, such as service oriented architecture, by determining an implementation plan based upon results of a survey provided to customer representatives. In an example embodiment, readiness is based at least in part upon responses to a survey provided by customer representatives. Customer representatives may be drawn from different parts of the customer enterprise organization. This ability providing an implementation plan for service oriented architecture from responses to a computer based survey or the like makes it possible to attain improved recommendations for customers over conventional IT consulting mechanisms that are based upon lengthy customer visits and on-site studies.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The current invention relates generally to Service Oriented Architecture (SOA), and more particularly to techniques for providing an implementation plan for service oriented architecture.

### BACKGROUND

Service Oriented Architecture (SOA) is an IT architecture made up of service components and interconnections promises to provide greater interoperability and location transparency for IT users than previously attainable. SOA enables reusable, exposable services that can be used alone or combined in order to provide applications that meet the functional needs of business and other enterprises.

Transitioning to a new enterprise wide architecture, such as SOA, is not without difficulty, however. Because such architectures are truly enterprise-wide, adoption of these architectures by an enterprise requires understanding and organization by all groups within the enterprise. Conventional implementation and marketing techniques, such as lengthy customer engagements, on-site studies and the like, become unwieldy and cumbersome when applied to analyzing requirements of customers for architectures such as SOA that have the potential to impact all facets and all locations of the enterprise.

What is needed are improved techniques for providing implementation plans for service oriented architecture that address these and other limitations of the conventional approaches.

### BRIEF DESCRIPTION OF THE DRAWINGS

FIG. 1 is functional block diagram of an example computing environment enabled for service oriented architecture in an embodiment.

FIG. 2 is an operational flow diagram illustrating a high level overview of a technique for providing an implementation plan for a service oriented architecture in accordance with an embodiment.

FIG. 3 is a diagram illustrating a high level overview of a set of domains in accordance with a multi domain model in an embodiment.

FIG. 4 is a diagram illustrating a high level overview of aggregating responses by calculating a total score by domain for a customer and for a peer group to which the customer belongs in an embodiment.

FIG. 5 is a diagram illustrating a high level overview of mapping a total score for each domain to a plurality of readiness stages in an embodiment.

FIG. 6A is a diagram illustrating a high level overview of a result produced in accordance with a technique described above with reference to FIG. 2 in an embodiment.

FIG. 6B is a diagram illustrating a high level overview of an implementation plan produced in accordance with a technique described above with reference to FIG. 2 in an embodiment

FIG. 7 is a hardware block diagram of an example computer system, which may be used to embody one or more components of an embodiment.

### DETAILED DESCRIPTION

The invention is illustrated by way of example and not by way of limitation in the figures of the accompanying drawings in which like references indicate similar items. References to embodiments in this disclosure are not necessarily to the same embodiment, and such references mean at least one. While specific implementations are discussed, it is understood that this is done for illustrative purposes. A person skilled in the relevant art can recognize that other components and configurations may be used without departing from the scope and spirit of the invention.

In the following description, numerous specific details are set forth to provide a thorough description of the invention. However, it can be apparent to one skilled in the art that the invention may be practiced without these specific details. In other instances, well-known features have not been described in detail so as not to obscure the invention.

Although a diagram may depict components as logically separate, such depiction is merely for illustrative purposes. It can be apparent to those skilled in the art that the components portrayed can be combined or divided into separate software, firmware and/or hardware components. For example, one or more of the embodiments described herein can be implemented in a network accessible device/appliance such as a router. Furthermore, it can also be apparent to those skilled in the art that such components, regardless of how they are combined or divided, can execute on the same computing device or can be distributed among different computing devices connected by one or more networks or other suitable communication means.

In accordance with embodiments of the present invention, there are provided mechanisms and methods for providing an implementation plan for service oriented architecture. These mechanisms and methods for providing an implementation plan make it possible for IT consultants and the like to have improved information about a customer's readiness to adopt an architecture, such as service oriented architecture, by determining an implementation plan based upon results of a survey provided to customer representatives. In an example embodiment, readiness is based at least in part upon responses to a survey provided by customer representatives. Customer representatives may be drawn from different parts of the customer enterprise organization. This ability providing an implementation plan for service oriented architecture from responses to a computer based survey or the like makes it possible to attain improved recommendations for customers over conventional IT consulting mechanisms that are based upon lengthy customer visits and on-site studies.

In an embodiment, a method for providing an implementation plan for service oriented architecture is provided. The method includes receiving at least one response to a computer based survey of questions in at least one domain. As used herein, the term domain is intended to be broadly construed to include any area of consideration, such as without limitation business process and strategy, architecture, building blocks, projects and applications, costs and benefits, organization and governance and other domains may be used in embodiments. The responses indicating an opinion of a customer of the customer's readiness to adopt a service oriented architecture. The responses are aggregated by calculating a total score by domain for the customer and for a peer group to which the customer belongs. The total score for each domain is mapped to a matrix of readiness stages to determine a readiness stage for the customer. The implementation plan is generated based on the readiness stage and the total score for the customer and for the peer group. The implementation plan indicates to an IT consultant the customer's needs to be satisfied in each domain in order for the customer to be able to adopt the service oriented architecture.

Enterprise information is typically not all stored in a single data store, such as a database, but can be instead stored in individual silos from which each enterprise application must drink. Each silo can have its own differentiating features (e.g., storage mechanism, storage format, storage access mechanism, etc.). In an attempt to bring some order to the sea of information chaos, enterprises are turning to a Service Oriented Architecture (SOA) approach to integration. Using this architectural approach, the capabilities of applications and the access mechanisms to information sources are exposed as services. Services hide underlying implementation details from application programs.

Information sources are exposed as services. This concept focuses on hiding the implementation and access mechanism details of a given information source behind a service based interface (or façade). While an SOA approach could be done with any number of technologies, one embodiment uses of XML and Web Services. Using this approach, it is possible to hide whether the information source requires a SQL query, for example, to access the information within. Application development becomes focused on making service requests and handling service responses. In one embodiment, an information source can be turned into a service through use of a service proxy or a service adapter.

A service proxy can serve as an external wrapper which is installed in front of an information source, an application or a service. The proxy acts as a gateway and a façade through which access to the information source is performed. By way of illustration, a service proxy for accessing files in a file system could be created to access a file anywhere in a file system or be restricted to only certain areas of the file system. By way of further illustration, service proxies can hide the details of what a requesting entity or “consumer” is required to do in order to establish a session with the information source, transform the service request into the appropriate set of interactions in order to retrieve or update the information service, and then format the information to be returned to the consumer. By way of yet another illustration, the service proxy may hide the additional steps required to determine the actual results to be returned (e.g., the retrieval of additional meta-data, such as data sensitivity labels that may be stored in yet another information store, that need to be retrieved and evaluated before particular portions of the result set are to be returned).

In one embodiment, a service adapter is an embedded or integrated form of a service proxy. A service adapter is integrated into the request/response processing logic of a process (e.g., an information source) rather than operating externally from it.

In one embodiment, the SOA approach is extended with a service bus switching fabric. The service bus can provide the flexibility to allow data transformations and other services to be “plugged” into the bus and then reused by any number of different services and application components. This removes the need to hardwire a particular processing flow of services by allowing the processing flow to be described and then dynamically assembled. In one embodiment, applications can be assembled from any of the services which are “plugged” into the bus to create new information-based applications. In addition, through the orchestration of services, using standards such as Business Process Execution Language (BPEL), it is possible to dynamically change how an information technology infrastructure utilizes information sources, performs the data transformations, and incorporates capabilities provided by and to external partners to allow an enterprise to more efficiently execute its mission.

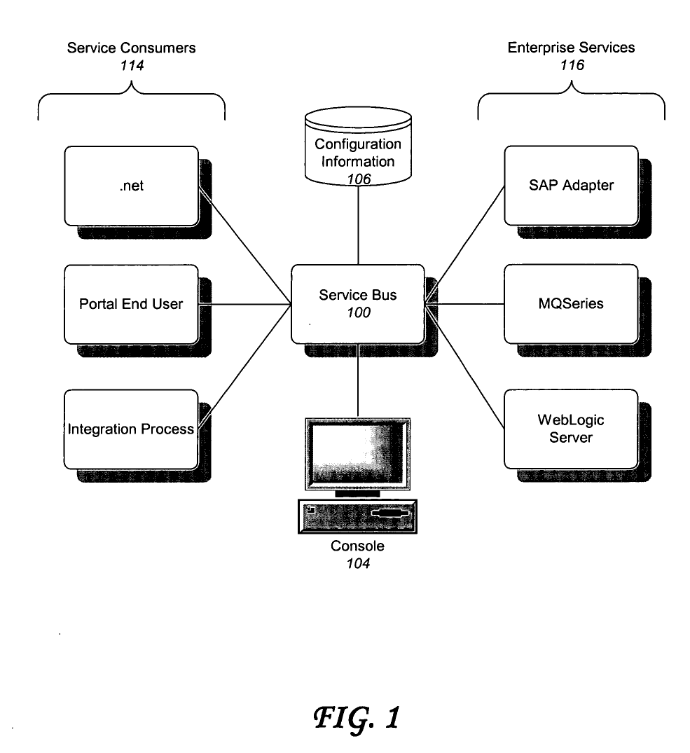

FIG. 1 is functional block diagram of an example computing environment enabled for service oriented architecture in an embodiment. As shown by FIG. 1 and by way of example, a computing environment includes a service bus 100 that represents a fusion of message brokering, web services, business-to-business (B2B) web services gateway and web services management concepts into a combination centered around a runtime configuration information directory/repository 106 and console 104. The service bus is an easy to use configuration-driven intermediary that accomplishes (without limitation) the following efficiently and with high availability, scalability and reliability:

Bridges the gap between what message sender 114 sends and what receiver 116 expects in the area of envelope protocol, transport protocol, security scheme, payload contents, one way and request/response paradigms, synchronous and asynchronous communication, point-to-point, and publish/subscribe.

Provides additional computing capability to perform tasks such as (but not limited to) multi-destination publish, content based routing, authentication and authorization, and credential mapping.

Provides monitoring capability with metrics collection and display, alert displays, tracking event collection and use, message archiving and Service Level Agreement (SLA) management.

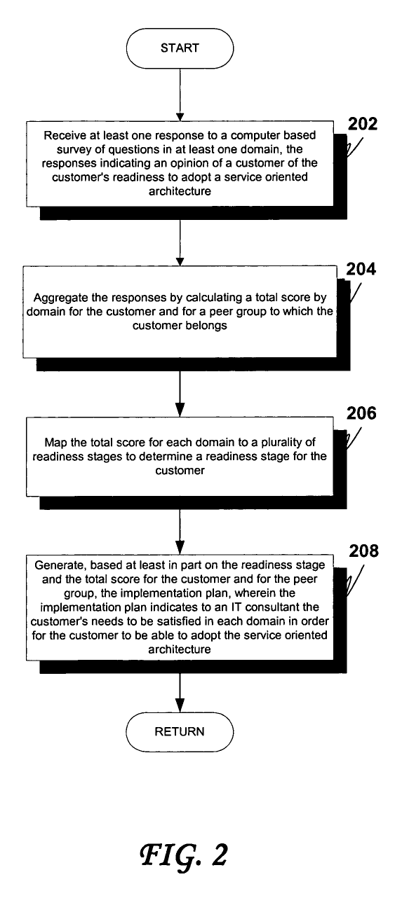

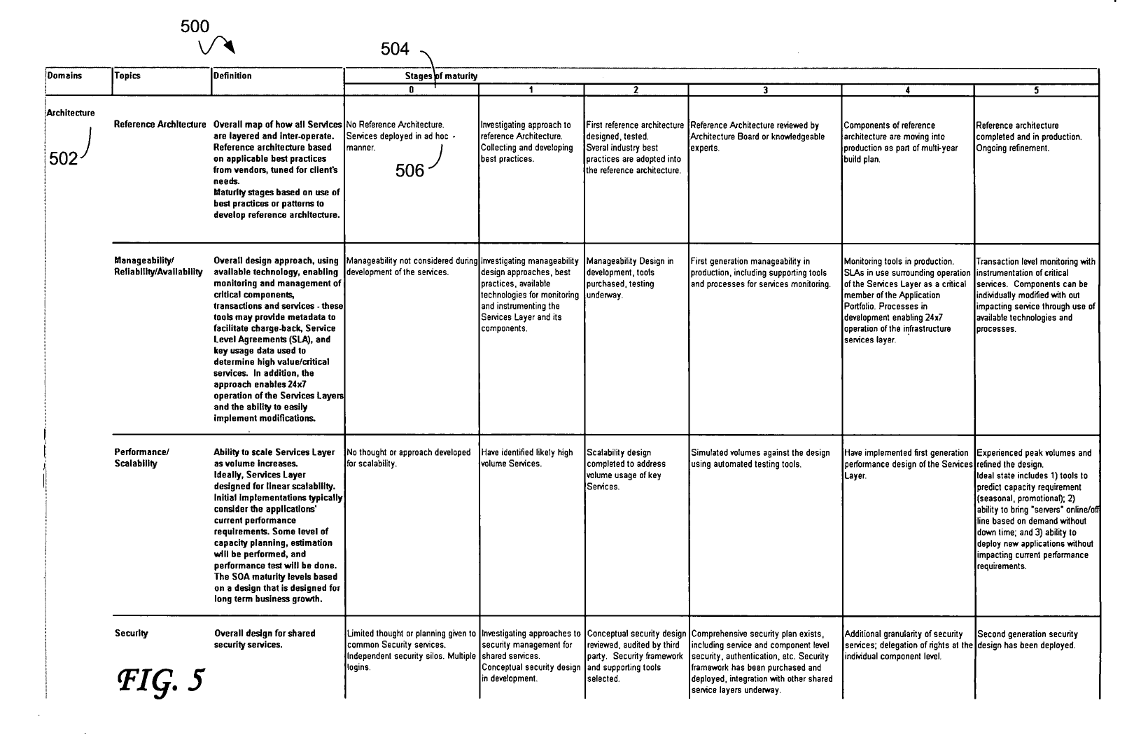

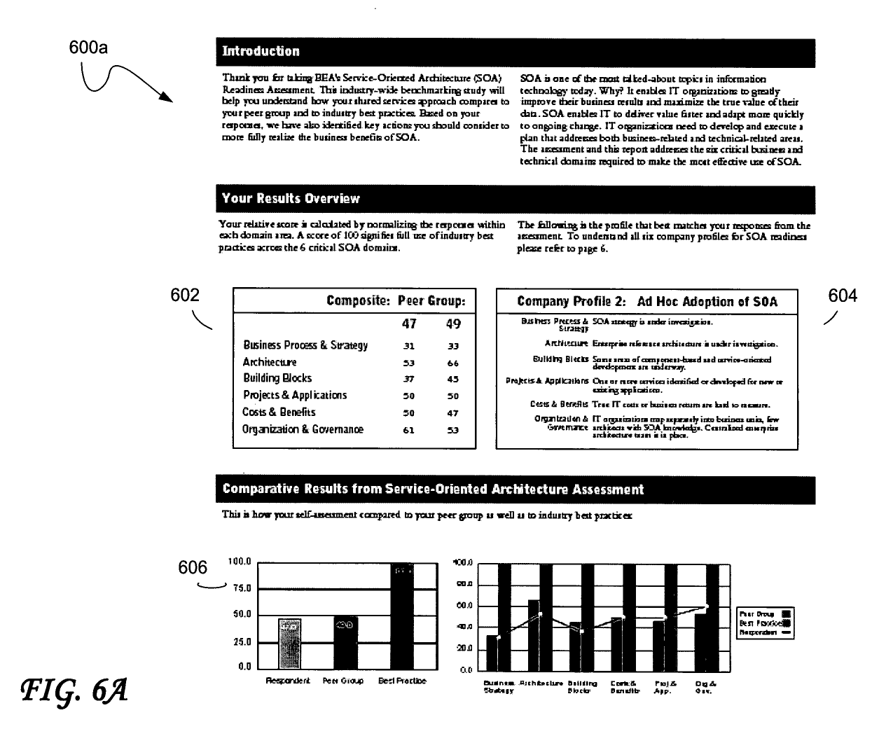

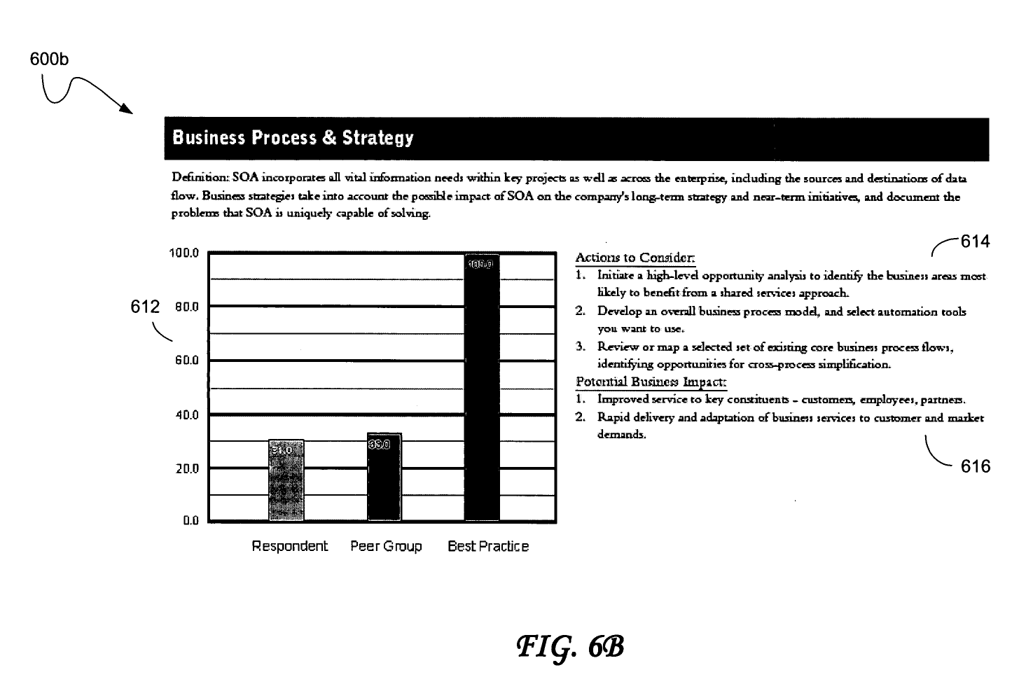

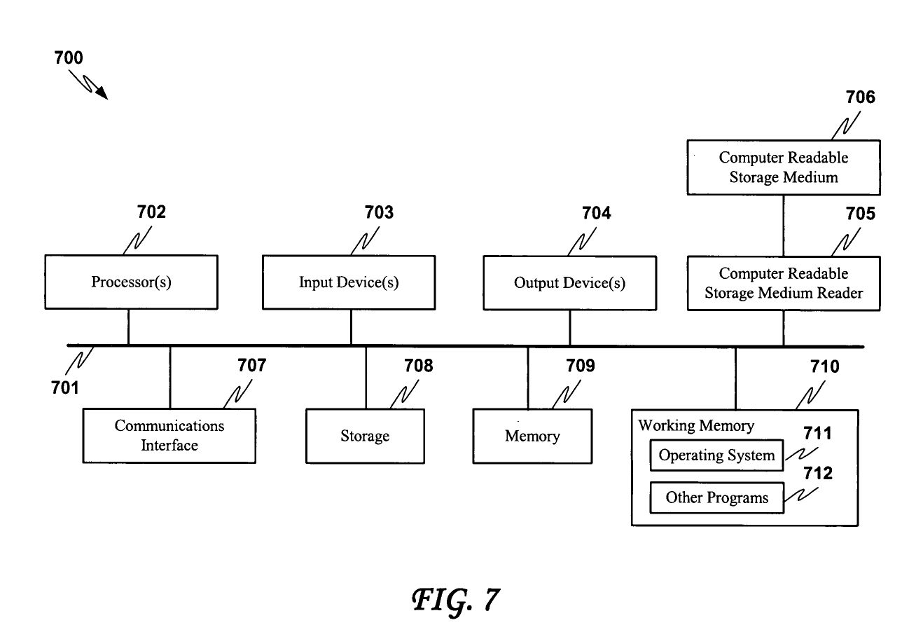

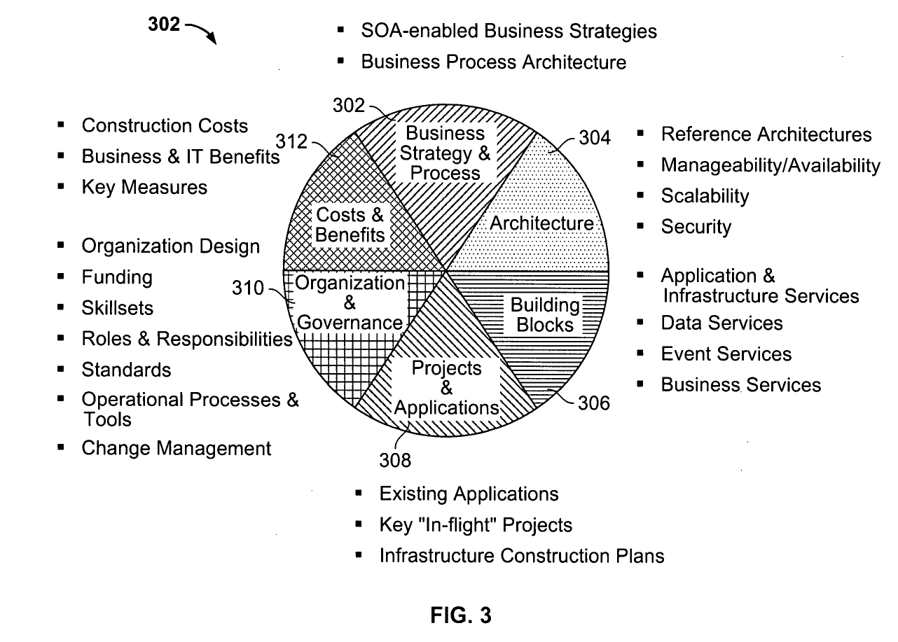

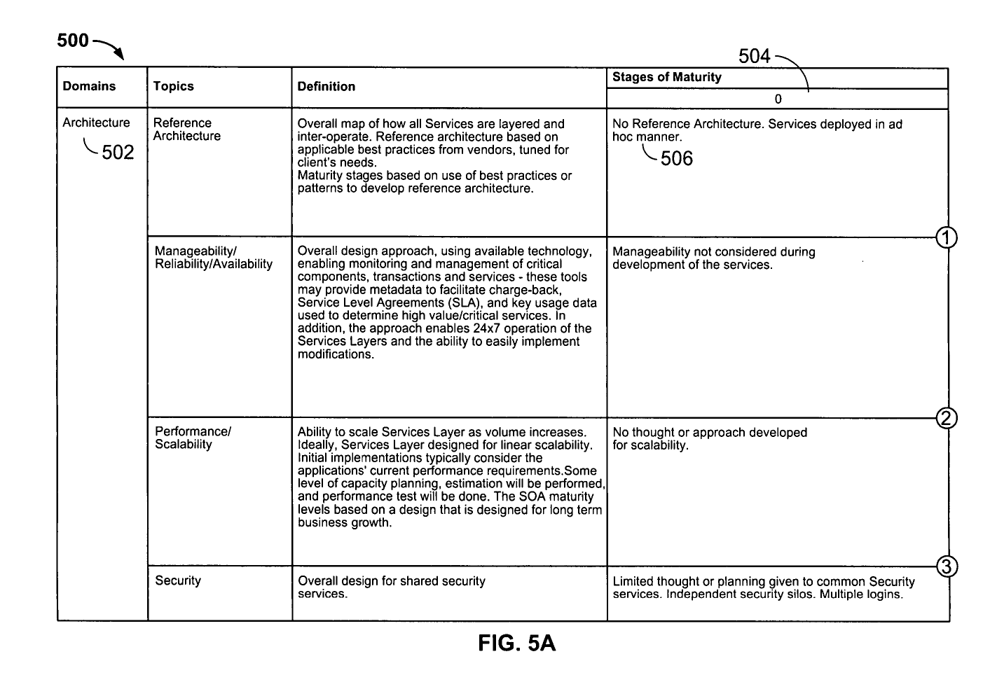

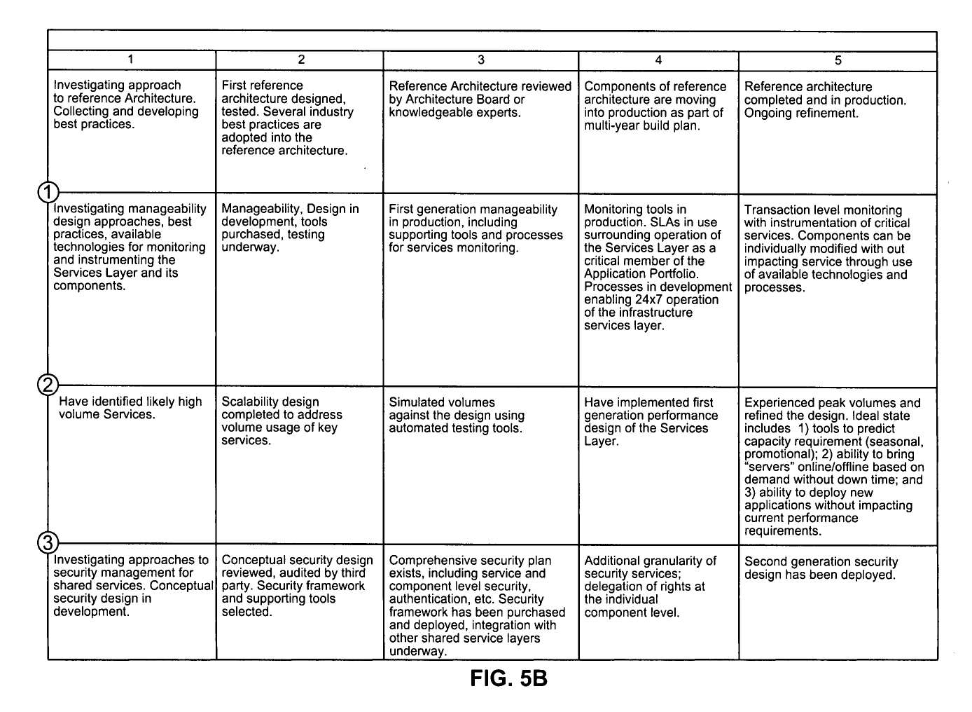

FIG. 2 is an operational flow diagram illustrating a high level overview of a technique for providing an implementation plan for implementing a service oriented architecture in accordance with an embodiment. As shown in FIG. 2, at least one response to a computer based survey of questions in at least one domain is received (block 202). The responses indicate an opinion of a customer of the customer's readiness to adopt a service oriented architecture. The responses are aggregate by calculating a total score by domain for the customer and for a peer group to which the customer belongs (block 204). The total score for each domain is mapped to a plurality of readiness stages to determine a readiness stage for the customer (block 206). In an embodiment, the plurality of readiness stages may be organized according to a matrix as illustrated by FIG. 5. The implementation plan is generated based at least in part on the readiness stage and the total score for the customer and for the peer group (block 208). The implementation plan indicates to an IT consultant the customer's needs to be satisfied in each domain in order for the customer to be able to adopt the service oriented architecture. Some embodiments may generate other results in addition to the implementation plan. Alternate embodiments may generate other results instead of an implementation plan.

While the present invention is described with reference to an embodiment in which the processes illustrated by FIG. 2 are executable programs written in the Java™ programming language and usually (though not always) executed in response to an invocation from an HTML page, the present invention is not limited to the Java™ programming language and may be practiced using other programming languages, i.e., JSP and the like without departing from the scope of the embodiments claimed. (Java™ is a trademark of Sun Microsystems, Inc.) In one embodiment, the processing of FIG. 2 is implemented using an application server product, such as WebLogic® Server by BEA systems of San Jose, Calif.

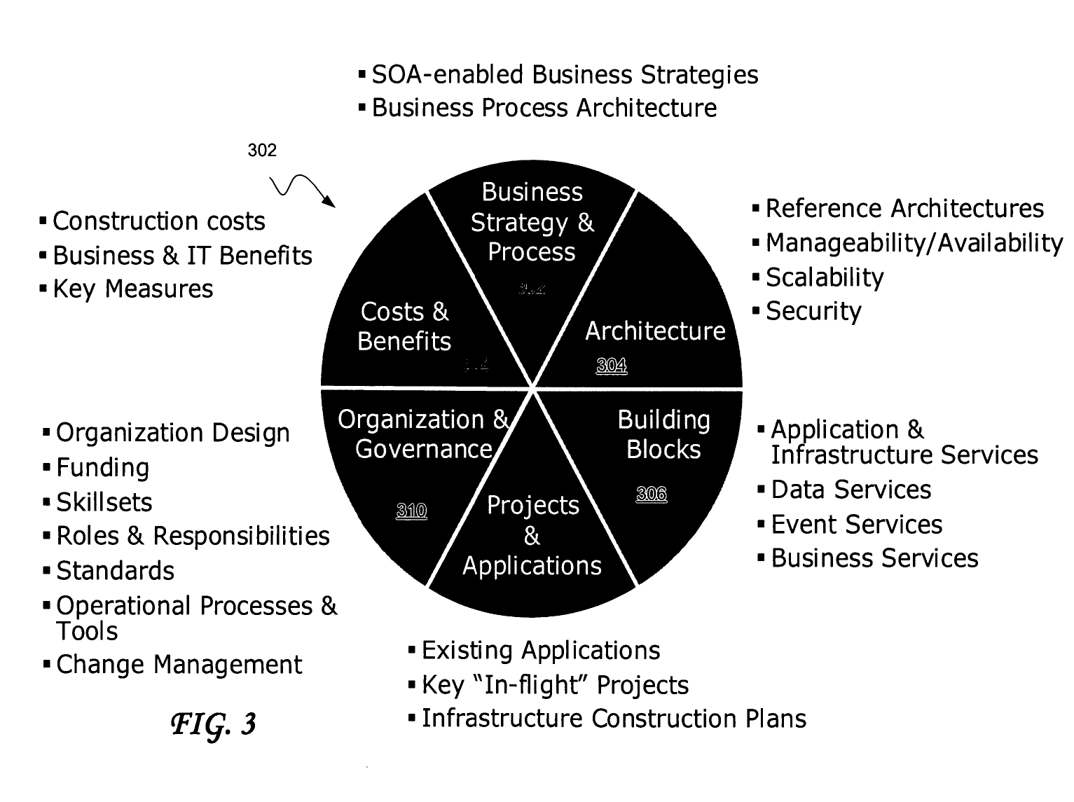

FIG. 3 is a diagram illustrating a high level overview of a set of domains in accordance with a multi domain model in an embodiment. Responses to a computer based survey of questions may be received according to a domain to which each of the questions is applicable. As shown by FIG. 3, an embodiment of a set of domains includes domains business process and strategy 302, architecture 304, building blocks 306, projects and applications 308, costs and benefits 310, and organization and governance 312. An organization's readiness to adopt SOA may be evaluated for each domain by comparing scores determined from responses to the survey in each domain to scores of a peer group. Accordingly, an organization—wide comparison of survey responders' views of SOA readiness of their own organizations to be determined.

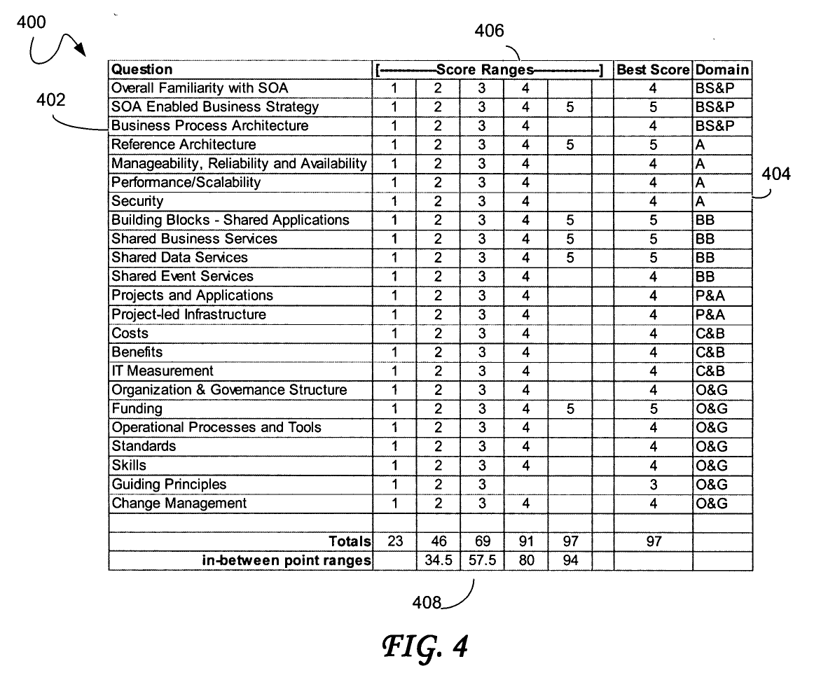

FIG. 4 is a diagram illustrating a high level overview of aggregating responses by calculating a total score by domain for a customer and for a peer group to which the customer belongs in an embodiment. As shown in FIG. 4, a computer based survey comprises of questions 402 for one or more domains 404. Responses indicating an opinion of a customer of the customer's readiness to adopt a service oriented architecture are scored into score ranges 406. A total score may be developed by aggregating the responses by domain for a customer and for a peer group of the customer. In an embodiment, the total score may be compared against a best possible score 408. The ranges and scores may be used to obtain a readiness indication for the customer in a particular domain. In alternate embodiments, the score may be weighted, scaled or have other transformations applied to it in order to facilitate arriving at a readiness indication for the customer without departing from the scope of the claimed embodiments.

FIG. 5 is a diagram illustrating a high level overview of mapping a total score for each domain to a plurality of readiness stages in an embodiment. In FIG. 5, a mapping of total scores to readiness stages 500 includes a total score for domain 502 that is mapped to a plurality of readiness stages, such as readiness stage 504 for example, to determine a readiness stage for the customer. The mapping of total scores to readiness stages 500 is accomplished using a matrix organization of readiness stages. An intersection of a domain 502 with a readiness stage 504 includes one or more of at least one assertion 506 about the readiness of the customer, at least one potential action (not shown) for the customer's consideration, and at least one potential impact (not shown) of taking the at least one potential action. While mapping of total scores to readiness stages 500 is illustrated diagrammatically, those skilled in the art will appreciate that the logic shown by FIG. 5 may be realized using software, hardware or combinations thereof in embodiments.

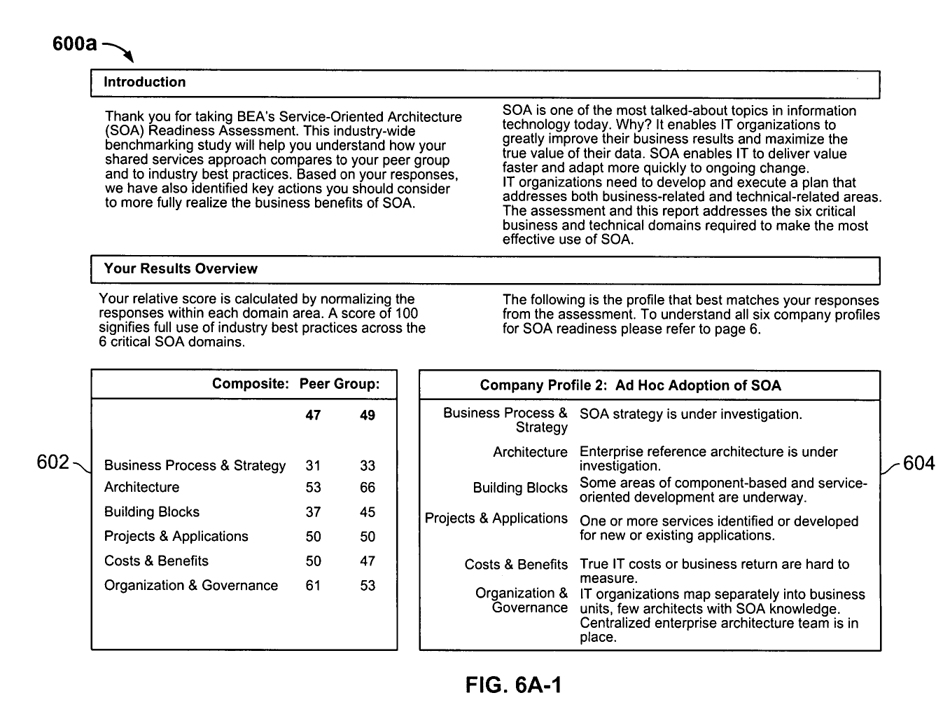

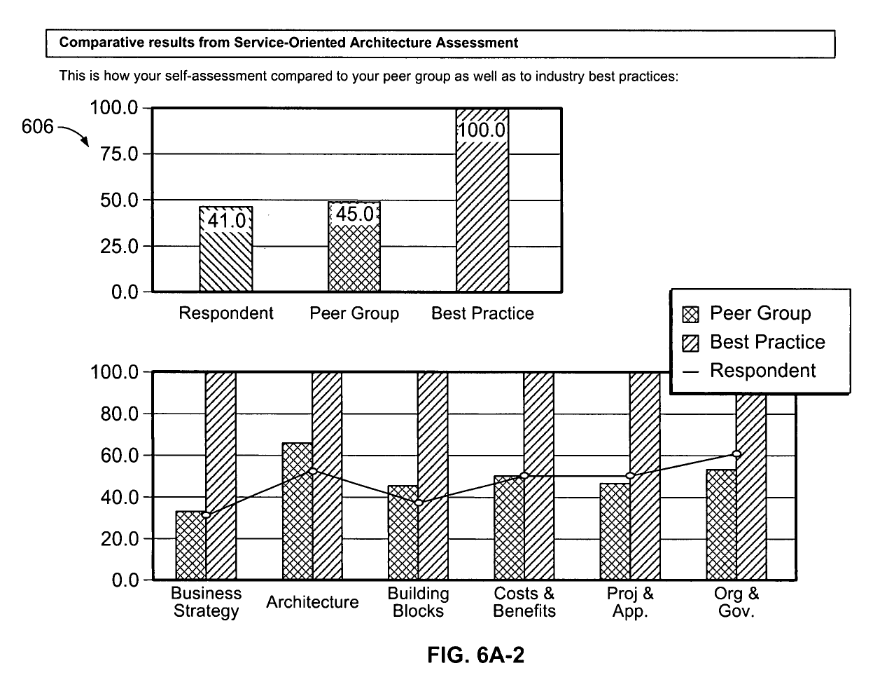

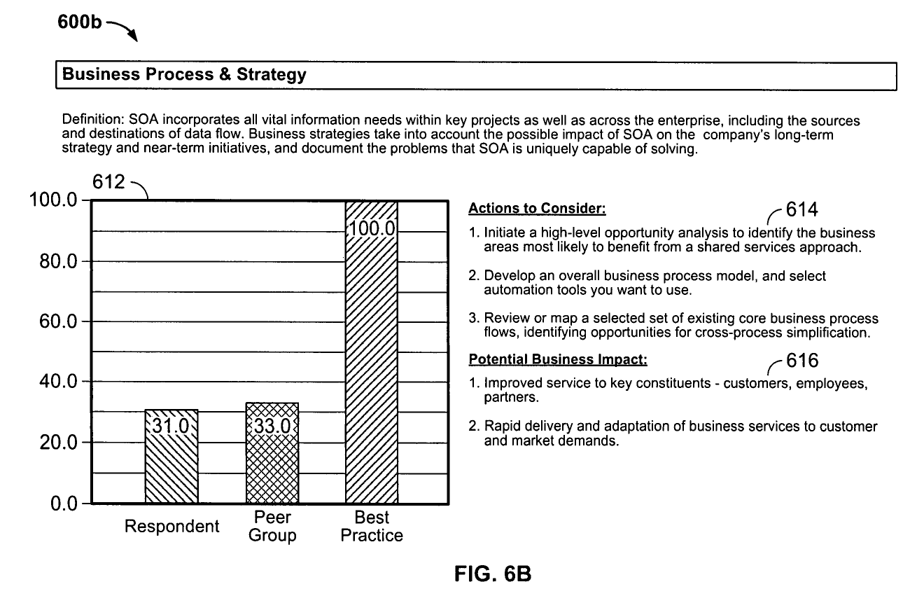

FIG. 6A is a diagram illustrating a high level overview of a result produced in accordance with a technique described above with reference to FIG. 2. As shown by FIG. 6A, an example result 600a comprises a plurality of devices for indicating results. For example, a respondent's relative score versus the peer group 602 indicates how the customer's responses compare with the customer's peer group in each domain. A Service-Oriented Architecture customer profile that best matches the overall score 604 provides information about the readiness category that has been determined for the customer based upon the customer's responses. Another set of devices 606 indicate how a respondent's self-assessment results compared to the peer group as well as industry best practices.

In an embodiment, the result of determining readiness stage for the customer in each of the domains, as well as the total score for the customer and the peer group may be used to generate an implementation plan for the customer. As shown by FIG. 6B, an implementation plan can be produced in accordance with a technique described above with reference to FIG. 2 in an embodiment. The implementation plan 600b can provide indications to an IT consultant about the customer's needs to be satisfied in each domain in order for the customer to be able to adopt the service oriented architecture. For example, a results by domain 612 shows areas which may need more focus. A recommendations 614 provides some recommendations that the customer may want to consider in adopting SOA. A Summary 616 provides a summary of potential business impact of adopting SOA for each domain.

The result 600a and implementation plan 600b can enable IT professionals to make recommendations to the customer. For example, a total score for the customer that is less than the total score for the peer group may indicate that the customer needs to understand how service oriented architecture can help the customer achieve the customer's business strategy. On the other hand, a total score for the customer that is greater than the total score for the peer group may indicate that academic knowledge of service oriented architecture by the customer may exceed practical ability to implement service oriented architecture for the customer. In another possibility, a total score for the customer that is approximately equal to the total score for the peer group may indicate that the customer does not yet have structures in place to implement using services extracted from existing applications. Of course, other inferences may be drawn based upon the implementation plans, total and ranged scores and comparison scores of the customer's responses with that of the customer's peer group without departing from the scope of the claimed embodiments.

In other aspects, the invention encompasses in some embodiments, computer apparatus, computing systems and machine-readable media configured to carry out the foregoing methods. In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of rotating media including floppy disks, optical discs, DVD, CD-ROMs, microdrive, and magneto-optical disks, and magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention, including, but not limited to providing mechanisms and methods for providing an implementation plan for service oriented architecture as discussed herein.

FIG. 7 illustrates an exemplary processing system 700, which can comprise one or more of the elements upon which the processes of FIG. 2 may be implemented. While other alternatives might be utilized, it will be presumed for clarity sake that the processes illustrated by FIG. 2 are implemented in hardware, software or some combination by one or more computing systems consistent therewith, unless otherwise indicated.

Computing system 700 comprises components coupled via one or more communication channels (e.g., bus 701) including one or more general or special purpose processors 702, such as a Pentium®, Centrino®, Power PC®, digital signal processor (“DSP”), and so on. System 700 components also include one or more input devices 703 (such as a mouse, keyboard, microphone, pen, and so on), and one or more output devices 704, such as a suitable display, speakers, actuators, and so on, in accordance with a particular application. (It will be appreciated that input or output devices can also similarly include more specialized devices or hardware/software device enhancements suitable for use by the mentally or physically challenged.)

System 700 also includes a computer readable storage media reader 705 coupled to a computer readable storage medium 706, such as a storage/memory device or hard or removable storage/memory media; such devices or media are further indicated separately as storage 708 and memory 709, which may include hard disk variants, floppy/compact disk variants, digital versatile disk (“DVD”) variants, smart cards, read only memory, random access memory, cache memory, and so on, in accordance with the requirements of a particular application. One or more suitable communication interfaces 707 may also be included, such as a modem, DSL, infrared, RF or other suitable transceiver, and so on for providing inter-device communication directly or via one or more suitable private or public networks or other components that may include but are not limited to those already discussed.

Working memory 710 further includes operating system (“OS”) 711 elements and other programs 712, such as one or more of application programs, mobile code, data, and so on for implementing system 700 components that might be stored or loaded therein during use. The particular OS or OSs may vary in accordance with a particular device, features or other aspects in accordance with a particular application (e.g. Windows®, WindowsCE™, Mac™, Linux, Unix or Palm™ OS variants, a cell phone OS, a proprietary OS, Symbian™, and so on). Various programming languages or other tools can also be utilized, such as those compatible with C variants (e.g., C++, C#), the Java™ 2 Platform, Enterprise Edition (“J2EE”) or other programming languages in accordance with the requirements of a particular application. Other programs 712 may further, for example, include one or more of activity systems, education managers, education integrators, or interface, security, other synchronization, other browser or groupware code, and so on, including but not limited to those discussed elsewhere herein.

When implemented in software (e.g. as an application program, object, agent, downloadable, servlet, and so on in whole or part), a learning integration system or other component may be communicated transitionally or more persistently from local or remote storage to memory (SRAM, cache memory, etc.) for execution, or another suitable mechanism can be utilized, and components may be implemented in compiled or interpretive form. Input, intermediate or resulting data or functional elements may further reside more transitionally or more persistently in a storage media, cache or other volatile or non-volatile memory, (e.g., storage device 708 or memory 709) in accordance with a particular application.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for providing an implementation plan for service oriented architecture, the method comprising:
receiving at least one response to a computer based survey of questions in at least one domain, the responses indicating an opinion of a customer of the customer's readiness to adopt a service oriented architecture;
aggregating the responses by calculating a total score by domain for the customer and for a peer group to which the customer belongs;
mapping the total score for each domain to a plurality of readiness stages to determine a readiness stage for the customer; and
generating, based at least in part on the readiness stage and the total score for the customer and for the peer group, the implementation plan, wherein the implementation plan indicates to an IT consultant the customer's needs to be satisfied in each domain in order for the customer to be able to adopt the service oriented architecture.

2. The method of claim 1, wherein receiving at least one response to a computer based survey of questions in at least one domain comprises receiving at least one response to a computer based survey of questions in at least one of:
business process and strategy, architecture, building blocks, projects and applications, costs and benefits, and organization and governance.

3. The method of claim 1, wherein aggregating the responses by calculating a total score by domain for the customer and for a peer group to which the customer belongs comprises:
applying a weighting to the total score.

4. The method of claim 1, wherein mapping the total score for each domain to a plurality of readiness stages to determine a readiness stage for the customer comprises:
mapping the total score for each domain to a matrix of readiness stages to determine a readiness stage for the customer.

5. The method of claim 4, wherein mapping the total score for each domain to a matrix of readiness stages to determine a readiness stage for the customer comprises mapping the total score for each domain to a maturity matrix of domains and readiness stages and wherein an intersection of a domain with a readiness stage includes at least one of:
at least one assertion about the readiness of the customer,
at least one potential action for the customer's consideration, and
at least one potential impact of taking the at least one potential action.

6. The method of claim 1, wherein generating, based at least in part on the readiness stage and the total score for the customer and for the peer group, the implementation plan, wherein the implementation plan indicates to an IT consultant the customer's needs to be satisfied in each domain in order for the customer to be able to adopt the service oriented architecture comprises:
indicating to the IT consultant that the customer needs to understand how service oriented architecture can help the customer achieve the customer's business strategy, if the total score for the customer is less than the total score for the peer group.

7. The method of claim 1, wherein generating, based at least in part on the readiness stage and the total score for the customer and for the peer group, the implementation plan, wherein the implementation plan indicates to an IT consultant the customer's needs to be satisfied in each domain in order for the customer to be able to adopt the service oriented architecture comprises:
indicating to the IT consultant that academic knowledge of service oriented architecture may exceed practical ability to implement service oriented architecture for the customer, if the total score for the customer is greater than the total score for the peer group.

8. The method of claim 1, wherein generating, based at least in part on the readiness stage and the total score for the customer and for the peer group, the implementation plan, wherein the implementation plan indicates to an IT consultant the customer's needs to be satisfied in each domain in order for the customer to be able to adopt the service oriented architecture comprises:
indicating to the IT consultant that the customer does not yet have structures in place to implement using services extracted from existing applications, if the total score for the customer is approximately equal to the total score for the peer group.

9. The method of claim 1, further comprising:
providing the survey to a plurality of customer representatives in at least two disparate portions of the customer's organization.

10. The method of claim 9, wherein generating, based at least in part on the readiness stage and the total score for the customer and for the peer group, the implementation plan, wherein the implementation plan indicates to an IT consultant the customer's needs to be satisfied in each domain in order for the customer to be able to adopt the service oriented architecture comprises:
indicating to the IT consultant domains in which differences of opinion exist within the customer's organization based at least in part on disparities identified in computing the total score for each of the plurality of customer representatives.

11. A computer-readable medium carrying one or more sequences of instructions for providing an implementation plan for service oriented architecture, which instructions, when executed by one or more processors, cause the one or more processors to carry out the steps of:
receiving at least one response to a computer based survey of questions in at least one domain, the responses indicating an opinion of a customer of the customer's readiness to adopt a service oriented architecture;
aggregating the responses by calculating a total score by domain for the customer and for a peer group to which the customer belongs;
mapping the total score for each domain to a plurality of readiness stages to determine a readiness stage for the customer; and
generating, based on the readiness stage and the total score for the customer and for the peer group, the implementation plan, wherein the implementation plan indicates to an IT consultant the customer's needs to be satisfied in each domain in order for the customer to be able to adopt the service oriented architecture.

12. The computer-readable medium as recited in claim 11, wherein the instructions for carrying out the step of receiving at least one response to a computer based survey of questions in at least one domain include instructions for carrying out the step of receiving at least one response to a computer based survey of questions in at least one of:
business process and strategy, architecture, building blocks, projects and applications, costs and benefits, and organization and governance.

13. The computer-readable medium as recited in claim 11, wherein the instructions for aggregating the responses by calculating a total score by domain for the customer and for a peer group to which the customer belongs include instructions for carrying out the step of:
applying a weighting to the total score.

14. The computer-readable medium as recited in claim 11, wherein the instructions for mapping the total score for each domain to a plurality of readiness stages to determine a readiness stage for the customer include instructions for carrying out the step of:
mapping the total score for each domain to a matrix of readiness stages to determine a readiness stage for the customer.

15. The computer-readable medium as recited in claim 14, wherein the instructions for mapping the total score for each domain to a matrix of readiness stages to determine a readiness stage for the customer include instructions for carrying out the step of mapping the total score for each domain to a maturity matrix of domains and readiness stages and wherein an intersection of a domain with a readiness stage includes at least one of:
at least one assertion about the readiness of the customer,
at least one potential action for the customer's consideration, and
at least one potential impact of taking the at least one potential action.

16. The computer-readable medium as recited in claim 11, wherein the instructions for generating, based at least in part on the readiness stage and the total score for the customer and for the peer group, the implementation plan, wherein the implementation plan indicates to an IT consultant the customer's needs to be satisfied in each domain in order for the customer to be able to adopt the service oriented architecture include instructions for carrying out the step of:
indicating to the IT consultant that the customer needs to understand how service oriented architecture can help the customer achieve the customer's business strategy, if the total score for the customer is less than the total score for the peer group.

17. The computer-readable medium as recited in claim 11, wherein the instructions for generating, based at least in part on the readiness stage and the total score for the customer and for the peer group, the implementation plan, wherein the implementation plan indicates to an IT consultant the customer's needs to be satisfied in each domain in order for the customer to be able to adopt the service oriented architecture include instructions for carrying out the step of:
indicating to the IT consultant that academic knowledge of service oriented architecture may exceed practical ability to implement service oriented architecture for the customer, if the total score for the customer is greater than the total score for the peer group.

18. The computer-readable medium as recited in claim 11, wherein the instructions for generating, based at least in part on the readiness stage and the total score for the customer and for the peer group, the implementation plan, wherein the implementation plan indicates to an IT consultant the customer's needs to be satisfied in each domain in order for the customer to be able to adopt the service oriented architecture include instructions for carrying out the step of:
indicating to the IT consultant that the customer does not yet have structures in place to implement using services extracted from existing applications, if the total score for the customer is approximately equal to the total score for the peer group.

19. The computer-readable medium as recited in claim 11, further comprising instructions for carrying out the step of:
providing the survey to a plurality of customer representatives in at least two disparate portions of the customer's organization.

20. The computer-readable medium as recited in claim 19, wherein the instructions for generating, based at least in part on the readiness stage and the total score for the customer and for the peer group, the implementation plan, wherein the implementation plan indicates to an IT consultant the customer's needs to be satisfied in each domain in order for the customer to be able to adopt the service oriented architecture include instructions for carrying out the step of:
indicating to the IT consultant domains in which differences of opinion exist within the customer's organization based at least in part on disparities identified in computing the total score for each of the plurality of customer representatives.

21. An apparatus for providing an implementation plan for service oriented architecture, the apparatus comprising:
a processor; and
one or more stored sequences of instructions which, when executed by the processor,
cause the processor to carry out the steps of:
receiving at least one response to a computer based survey of questions in at least one domain, the responses indicating an opinion of a customer of the customer's readiness to adopt a service oriented architecture;
aggregating the responses by calculating a total score by domain for the customer and for a peer group to which the customer belongs;
mapping the total score for each domain to a plurality of readiness stages to determine a readiness stage for the customer; and
generating, based on the readiness stage and the total score for the customer and for the peer group, the implementation plan, wherein the implementation plan indicates to an IT consultant the customer's needs to be satisfied in each domain in order for the customer to be able to adopt the service oriented architecture.
